(19) United States
(12) Patent Application Publication
(10) Pub. No.: US 2016/0253677 A1
(43) Pub. Date: Sep. 1, 2016

(54) FRACTIONAL OWNERSHIP USING DIGITAL ASSETS

(71) Applicants: Hooman Azmi, Allendale, NJ (US); Salima Popatia, Jersey City, NJ (US); Reza Mazaheri, Jersey City, NJ (US); Sai Kong, New York, NY (US)

(72) Inventors: Hooman Azmi, Allendale, NJ (US); Salima Popatia, Jersey City, NJ (US); Reza Mazaheri, Jersey City, NJ (US); Sai Kong, New York, NY (US)

(21) Appl. No.: 15/152,681

(22) Filed: May 12, 2016

Related U.S. Application Data
(62) Division of application No. 13/672,569, filed on Nov. 8, 2012.
(60) Provisional application No. 61/557,705, filed on Nov. 9, 2011.

(51) Int. Cl. G06Q 30/00; G06Q 40/08; G06Q 30/02; G06Q 30/06

(52) U.S. Cl. CPC G06Q 30/018; G06Q 30/0609; G06Q 40/08; G06Q 30/0278

(57) ABSTRACT

A platform and method provided for facilitating the trading of fractional ownerships of a digital representation of an asset. In one embodiment, the method includes: identifying an original physical asset for creating a corresponding digital asset; making a digital representation of the original physical asset; authenticating the digital representation; embedding or associating the digital representation with a unique identification code; storing the digital representations on a first non-transitory computer-readable storage medium; and placing the digital representation in a market for trading.

### CROSS-REFERENCE TO RELATED APPLICATIONS

This application claims the benefit of U.S. Provisional Application No. 61/557,705, filed Nov. 9, 2011, the contents of which are incorporated by reference herein.

### FIELD OF THE INVENTION

The present invention relates to fractional ownership of assets generally, and more particularly, relates to a method and system for facilitating the trading of unique digital representations of a physical asset or a portion thereof. The present invention is applicable to digital assets that are tied to a physical asset, such as artwork, jewelry, real estate, etc.

### BACKGROUND

Many collectors and art enthusiasts purchase artwork pieces for investment purposes as well as for personal enjoyment. Some collectors also enjoy showing off their fine collections of artwork to friends, and to other art collectors and investors. However, some individuals do not have sufficient funds to build a high quality collection of artwork on their own, due to the fact that some art pieces are very expensive. Therefore, some art collectors/investors groups or trusts are created to cater the needs of these individuals. An art collectors group typically allows its members to pool their funds together so as to purchase artworks for the group's collection or portfolio. Each member thus has a fractional ownership of the collection. However, the ownership interest is largely undivided, and members cannot typically choose to own or not own a particular piece of artwork in the collection, although they may elect a portfolio manager for the group. If an individual joins an existing group, he/she has to accept partial ownership of all the artwork present in the collection, even though the individual may not like or want a particular piece. When an individual leaves the group, he/she has to give up his/her partial ownership of all the artwork in the collection, even though the individual may want to maintain his/her partial ownership in a particular piece of artwork. Membership movements in such art collectors group are typically very slow even if the collection contains only a single piece of artwork. Because membership movements are not fluid, partial ownerships of a piece of artwork are not traded efficiently, and thus the value of the piece of artwork may not truly reflect its market value.

Furthermore, the group members typically do not have physical possession of the artwork, at least not all at one time. Therefore, members may only be able to show off their collection in the form of photographs, prints, or replicas, which, by themselves, cannot provide actual proof of ownership, and do not carry the same prestige or uniqueness as the original.

### SUMMARY OF THE INVENTION

To address some of the above problems, partial ownerships of a piece of artwork, for example, are realized in the form of unique digital representations of the original artwork, each digital representation is tradable among buyers and sellers, and includes a proof of partial ownership of the original piece of artwork. Since the digital representations can be traded efficiently, they reflect more accurately their market value. Furthermore, a unique identification code associated with each digital representation allows authentication and maintains the prestige of actual ownership. The digital asset can be displayed, transferred, assigned, used as security or collateral, passed through a will, etc.

In one embodiment, the present invention provides a method for creating a tradable unique digital asset, including: identifying an original physical asset for creating a corresponding digital asset; making a digital representation of the original physical asset; authenticating the digital representation; embedding the digital representation with a unique identification code; storing the digital representations on a first non-transitory computer-readable storage medium; and placing the digital representation in a market for trading. The method may further include: generating a predetermined number of digital representations of the physical asset; selling a digital representation to a first user on a trading portal at a market price; and transferring the sold digital representation to a second non-transitory computer-readable storage medium. The physical asset may be appraised, fully insured and securely stored; and the digital representation may be authenticated.

In another embodiment, the present invention provides a system/platform for facilitating the trading of unique digital assets, including: a processing unit to embed a unique identification code into a digital representation of a physical asset; a first non-transitory computer-readable storage medium to store the digital representation; a trading portal to sell the digital representation to a first user at a market price, and to transfer the sold digital representation to a second non-transitory computer-readable storage medium. The system/platform may further include a digitizer to generate a predetermined number of digital representations of the physical asset.

In general the various aspects of the invention may be combined and coupled in any way possible within the scope of the invention. The foregoing and other features and advantages of the invention will be apparent from the following detailed description taken in conjunction with the accompanying drawings.

### BRIEF DESCRIPTION OF THE DRAWINGS

FIG. 1 shows a high level block diagram according to an embodiment of the invention.

FIG. 2 shows a high level process flow according to an embodiment of the invention.

FIG. 3 shows a trading platform according to an embodiment of the invention.

FIG. 4 shows a portfolio of digital assets according to an embodiment of the invention.

FIG. 5 shows a digital asset and its attributes according to an embodiment of the invention.

### DETAILED DESCRIPTION

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the exemplified embodiments. Accordingly, the invention expressly should not be limited to such exemplary embodiments illustrating some possible non-limiting combination of features that may exist alone or in other combinations of features; the scope of the invention being defined by the claims appended hereto.

This disclosure describes the best mode or modes of practicing the invention as presently contemplated. This description is not intended to be understood in a limiting sense, but provides an example of the invention presented solely for illustrative purposes by reference to the accompanying drawings to advise one of ordinary skill in the art of the advantages and construction of the invention. In the various views of the drawings, like reference characters designate like or similar parts.

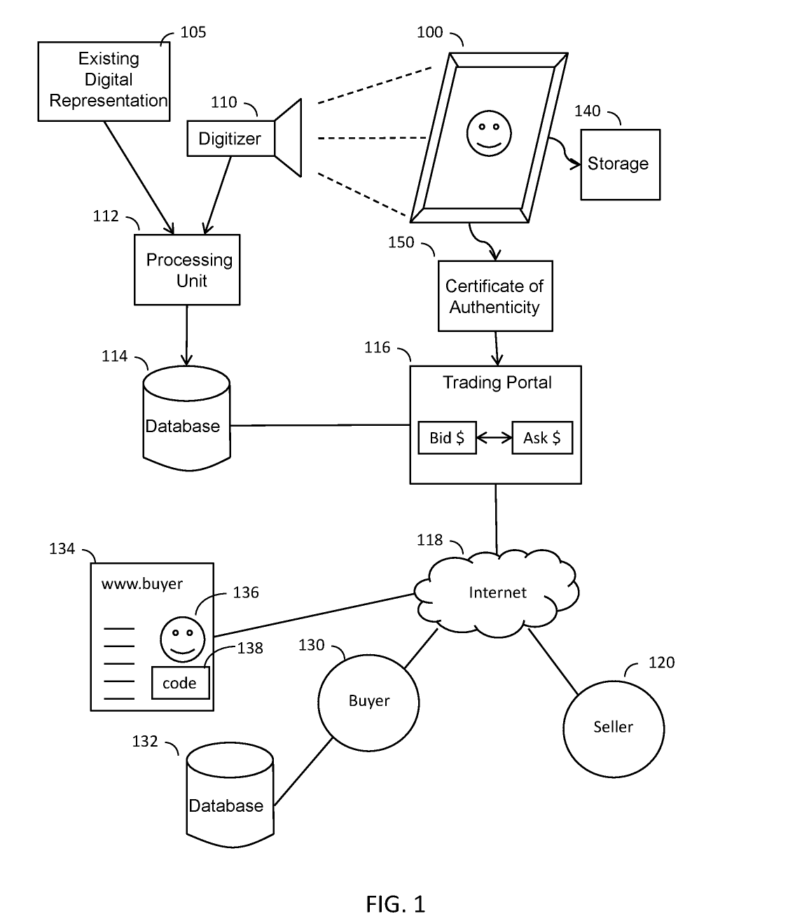

An embodiment of the invention is illustrated FIG. 1. A representation of a physical asset 100 (e.g., a painting, sculpture, arrangement, structure, photograph, audio clip, jewelry, real estate, etc) is created in digital form using a digitizer 110. The digitizer 110 may be, for example, a digital camera, camcorder, 3D imager, holographic imager, CT (Computerized Tomography) scanner, etc., which creates one or more digital sequences that constitute a digital representation of the artwork 100. Alternatively, if an existing digital representation 105 is available and can be authenticated, the existing digital representation 105 can be used. Each digital representation is encoded with a unique identification code 138 by a processing unit 112, and then is stored in a database 114. It is understood that the processing unit 112 may include a combination of processors, circuits, software and hardware components now known or hereinafter developed, and the database 114 may include a combination of non-transitory computer-readable storage media now known or hereinafter developed, e.g., hard drives, flash drives, DVDs, BluRay (trademark) disks, SD cards, etc. A trading portal 116 is connected to a seller 120 and a buyer 130 over a network 118 (e.g., the Internet) to allow a seller 120 and a buyer 130 to trade a partial ownership of the physical asset 100. It is understood that the trading portal may include a combination of hardware and software components in order to provide user interfaces for buyers and sellers to perform common online trading functions/activities, such as:

account setup, authentication, listing and browsing of assets, setting asking and bidding prices, execution of trades, and transfer of funds, etc. After the authenticity of the physical asset is verified by an appraiser or a central repository established to validate authenticity of digital assets, a certificate of authenticity 150 is issued, so that the trading portal 116 can provide potential buyers proof of authenticity of the digital asset. The original physical asset 100 or portion thereof must then be insured for its full value and preferably stored in a secured location 140. After purchasing the partial ownership, the buyer 130 downloads the digital representation to his/her own database 132. Other alternatives for the digital asset transfer include sending the digital file to the buyer via email, or via a physical storage medium, etc. The buyer 130 may demonstrate his/her partial owner-ship of the physical asset 100 by uploading and presenting a simulacrum 136 with the unique identification code 138, on a presentation medium/device, in this example, a webpage 134. In order to prevent dilution of share values, in one embodiment, the digital representation may only be uploaded to one webpage or to one online portal at any one time.

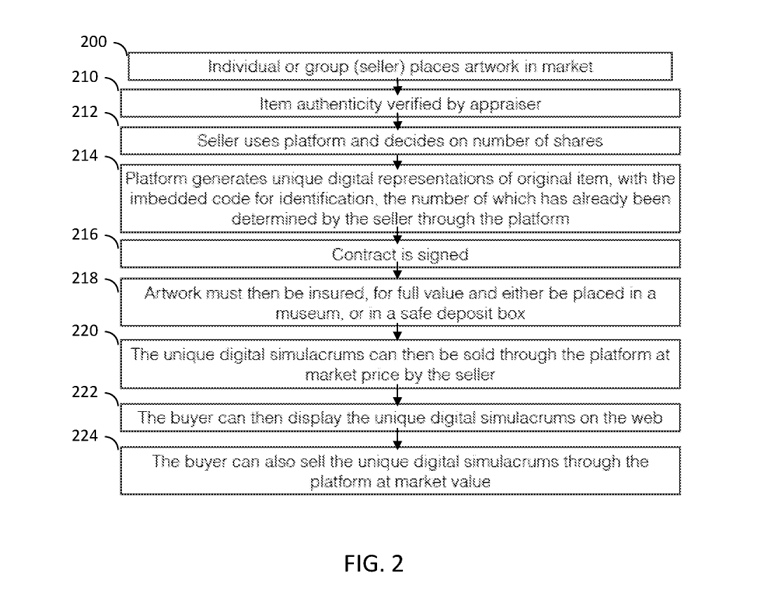

FIG. 2 shows the high level process steps according to an embodiment of the invention as applied to a piece of artwork, it being understood that the process can be applied to any asset. At 200, an individual or a group (seller wishes t_{O} place a piece of artwork in the market in units of fractional ownership. At 210, the authenticity of the piece of artwork is verified by an appraiser or a central repository established to validate authenticity of digital assets. The appraiser may also provide an appraised monetary value of the piece of artwork. At 212, the seller decides on the number of shares for the piece of artwork, thus determines the size of the fractional ownership. At 214, the platform generates unique digital representations of the original piece of artwork. Each digital representation is embedded with an identification code. The number of unique digital representations created is equal to the number of shares. At 216, the seller signs a contract to place the shares of partial ownership on the platform for sale. In order to protect the value of the shares, at 218, the original piece of artwork must then be insured for its full value, and stored in a secured location, such as a museum, a safe deposit box or a verifiable repository.

In one embodiment, the costs of insurance, appraisal, storage and other administrative expenses may be at least partially shared by the share owners. At 220, the unique digital representations can then be sold through the platform at market price by the seller. After a buyer acquires the partial ownership, the buyer can, at 222, display the unique simulacrums on a webpage or retain the partial ownership in a secure location, database, cloud server, or central depository. At 224, the buyer can also sell the unique simulacrums through the platform at market value. Note that the market value of the digital asset depends on market forces such as the supply and demand, and also on the intrinsic value of the original piece of artwork, as well as the environment and location of the storage and the condition and upkeeping of the original. For example, if the original item is stolen or damaged, the value of the digital representations is likely to decrease.

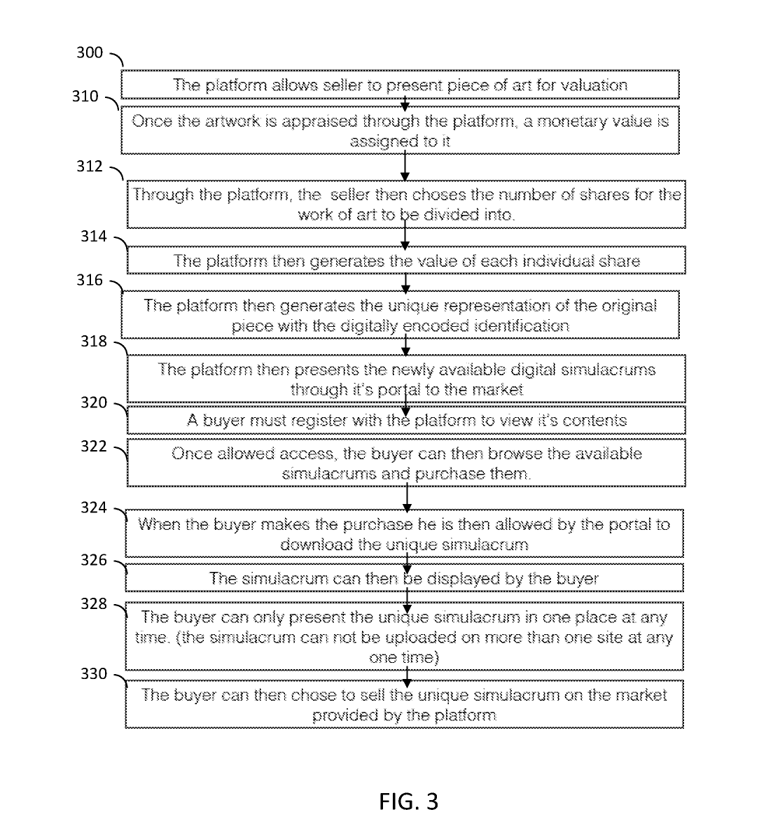

In an embodiment of the invention, the trading platform/system may perform some of the steps/functions shown in FIG. 3. The platform in the embodiment of FIG. 3 is set up as a market that allows a seller to sell a piece of artwork, it being understood that the platform can be utilized for any type of asset in addition to artwork. At 300, the platform accepts and allows a seller to present a piece of artwork for valuation. The platform may include market data and contact information for one or more appraisers to determine the value of the piece of artwork. At 310, once the piece of artwork is appraised through the platform, a monetary value is assigned to the piece of artwork. At 312, through the platform, the seller chooses the number of shares into which the piece of artwork is to be divided. At 314, the platform generates a value for each individual share based on the number of shares the seller created. At 316, the platform generates unique digital representations of the original piece of artwork, each with a digital encoded identification. At 318, the platform presents the newly available digital simulacrums to the marketplace through its portal.

Before a buyer can browse the content of the artwork collection available for sale, at 320, the buyer must register with the platform to view its contents. At 322, once the buyer is allowed access (after, for example, entering a user identification and password established during the registration at step 320), the buyer can then browse the available simulacrums and purchase them. At 324, when the buyer makes the purchase, the buyer is then allowed by the portal to download the unique simulacrum. At 326, the simulacrum can then be displayed by the buyer on a presentation medium/platform, such as a webpage, a digital picture frame, etc. At 328, the buyer can only present the unique simulacrum in one place at any time. The simulacrum is encoded with security and copy restriction features (such as, but not limited, to DRM for example) such that it cannot be uploaded on more than one webpage at any one time. At 330, the buyer can choose to sell the unique simulacrum on the market provided by the trading platform.

In an embodiment of the invention, the trading platform/system also performs an ownership recordation function, so that title/ownership of the digital assets can be ascertained. As the digital assets may be stored in non-transitory computer-readable storage media, it is possible that unauthorized copies can be made and distributed, thus diluting the share value of the digital asset. If buyers and sellers trade the digital asset outside of the trading platform/system, the authenticity of the asset is not guaranteed and the buyers risk that the title to the asset may not be free and clear. With the trading platform/system keeping records of title, change of ownership, assignment, lien, etc., a potential buyer can find out if there is any security interest attached to the digital asset. When a seller transfers the digital asset to a buyer, the trading platform/system can validate that the digital asset is authentic and update the ownership record in a database.

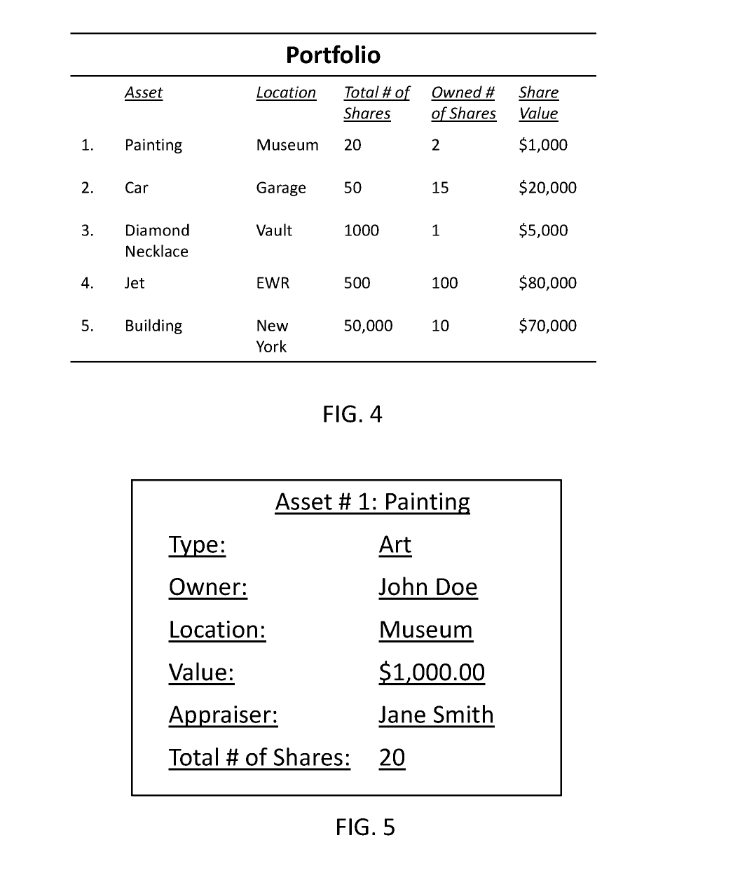

In an embodiment of the invention, the trading platform/system maintains a database of user portfolios of assets. The database may contain a list of assets, together with their respective storage location, total number of shares issued, number of shares owned by the user, and the value per share. FIG. 4 shows an example of a portfolio report for user. Each asset may be linked to its type, owner, location, value, appraiser and number of share. FIG. 5 shows an example of an asset with its attributes. Other combinations of data and reports are also contemplated.

The foregoing detailed description has set forth a few of the many forms that the invention can take. It is intended that the foregoing detailed description be understood as an illustration of selected forms that the invention can take and not as a limitation to the definition of the invention. It is only the claims, including all equivalents that are intended to define the scope of this invention.

Embodiments of the subject matter and the operations described in this specification can be implemented in digital electronic circuitry, or in computer software, firmware, or hardware, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. A computer storage medium can be, or be included in, a computer-readable storage device, a computer-readable storage substrate, a random or serial access memory array or device, or a combination of one or more of them. The computer storage medium can also be, or be included in, one or more separate physical components or media (e.g., multiple CDs, disks, or other storage devices).

The term “computer system” or “computer-based method” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code)can be written in any form of programming language, including compiled or interpreted languages, declarative or procedural languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA or an ASIC.

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by Which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

Most preferably, the principles of the invention are implemented as any combination of hardware, firmware and software. Moreover, the software is preferably implemented as an application program tangibly embodied on a program storage unit or computer readable storage medium consisting of parts, or of certain devices and/or a combination of devices. The application program may be uploaded to, and executed by, a machine comprising any suitable architecture. Preferably, the machine is implemented on a computer (platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such computer or processor is explicitly shown. In addition, various other peripheral units may be connected to the computer platform such as an additional data storage unit and a printing unit.

What is claimed is:

1. A platform for facilitating the trading of digital assets, comprising:
a processing unit to embed a unique identification code into a digital representation of a physical asset;
a first non-transitory computer-readable storage medium to store the digital representation;
a trading portal to sell the digital representation to a first user at a market price, and to transfer the sold digital representation to a second non-transitory computer-readable storage medium.

2. The platform of claim 1, further comprising a digitizer to generate a predetermined number of digital representations of the physical asset.

3. The platform of claim 2, wherein the processing unit is configured to:
assign each digital representation with a share value equal to an appraised value of the physical asset divided by the predetermined number.

4. The platform of claim 1, wherein the processing unit is configured to:
verify the authenticity of a digital representation shown on a presentation medium based on the unique identification code associated with the digital representation.

5. The platform of claim 1, wherein the processing unit is configured to:
apply a copy restriction feature to the digital representation so that the digital representation cannot be uploaded to more than one presentation medium at any one time.

6. The platform of claim 1, wherein the trading portal is configured to:
transfer the sold digital representation on the second non-transitory computer-readable storage medium to a third non-transitory computer-readable storage medium via the trading portal upon selling the digital representation by the first user to a second user.

7. The platform of claim 6, wherein the trading portal is further configured to:
update an ownership record upon selling the digital representation by the first user to the second user.

8. The platform of claim 1, wherein the trading portal is configured to:
issue a certificate of authenticity of the digital representation.

9. The platform of claim 1, wherein the processing unit is configured to:
generate a predetermined number of digital representations of the physical asset;
generate proof of authenticity of each of the predetermined number of digital representations;
store all of the digital representations on the first storage; and
place the digital representations for sale on the trading portal.

10. The platform of claim 9, wherein the processing unit is further configured to:
appraise a value of the physical asset; and
insure the value.

11. The platform of claim 10, wherein the processing unit is further configured to:
assign each digital representation with a share value equaled to the appraised value of the original physical asset divided by the predetermined number.

12. The platform of claim 9, wherein the processing unit is further configured to:
verify the authenticity of a digital representation shown on a presentation medium based on the unique identification code associated with the digital representation.

13. The platform of claim 9, wherein the processing unit is further configured to:
apply a copy restriction feature to the digital representation so that the digital representation cannot be uploaded to more than one presentation medium at any one time.

14. The platform of claim 9, wherein the trading portal is configured to transfer a first digital representation on the second storage to a third non-transitory computer-readable storage medium upon selling the digital representation by the first user to a second user.

15. The platform of claim 14, wherein the trading portal is further configured to update an ownership record upon selling the digital representation by the first user to a second user.

16. The platform of claim 1, wherein the physical asset is a piece of artwork.
